(19) United States
(12) Patent Application Publication
(10) Pub. No.: US 2023/0075193 A1
(43) Pub. Date: Mar. 9, 2023

(54) METHODS AND SYSTEMS FOR DYNAMIC FLEET PRIORITIZATION MANAGEMENT

(71) Applicant: GM GLOBAL TECHNOLOGY OPERATIONS LLC, Detroit, MI (US)

(72) Inventors: Lawrence A Bush, Shelby Township, MI (US); Joseph F Szczerba, Grand Blanc, MI (US); Roy J Mathieu, Rochester Hills, MI (US)

(73) Assignee: GM GLOBAL TECHNOLOGY OPERATIONS LLC, Detroit, MI (US)

(21) Appl. No.: 17/447,113

(22) Filed: Sep. 8, 2021

(51) Int. Cl. G06Q 10/06; G06Q 10/08; B60W 60/00; B60W 40/08

(52) U.S. Cl. CPC G06Q 10/063112; G06Q 10/08345; B60W 60/005; B60W 40/08

(57) ABSTRACT

Systems and method are provided for coordinating remote control of an autonomous vehicle by a remote transportation system. In one embodiment, a method includes: receiving, by a processor of the remote transportation system, request data requesting intervention of control of the autonomous vehicle; selecting, by the processor, an operator from a plurality of available operators; selectively assigning, by the processor, the selected operator to a task associated with the intervention based on at least one of a skill level of the selected operator, a workload of the selected operator, and an economic element of the ride associated with the selected operator; and coordinating, by the processor, control of the autonomous vehicle based on the assigned operator.

### TECHNICAL FIELD

The present disclosure generally relates to vehicles, and more particularly relates to systems and methods for managing assistance provided to autonomous vehicles in a fleet of autonomous vehicles.

A number of vehicles have one or more autonomous features. For example, an autonomous vehicle is a vehicle that is capable of sensing its environment and navigating with little or no user input. It does so by using sensors such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

In certain circumstances, it may be necessary for an operator to step in and provide assistance to the autonomous vehicle. In such circumstances, the assistance may be requested from a remote operator at a remote location. For example, the remote operator may oversee a fleet of the autonomous vehicles.

Accordingly, it is desirable to provide systems and methods for managing assistance provided to autonomous vehicles in a fleet of autonomous vehicles. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for coordinating remote control of an autonomous vehicle by a remote transportation system. In one embodiment, a method includes: receiving, by a processor of the remote transportation system, request data requesting intervention of control of the autonomous vehicle; selecting, by the processor, an operator from a plurality of available operators; selectively assigning, by the processor, the selected operator to a task associated with the intervention based on at least one of a skill level of the selected operator, a workload of the selected operator, and an economic element of the ride associated with the selected operator; and coordinating, by the processor, control of the autonomous vehicle based on the assigned operator.

In various embodiments, the selecting the operator from the plurality of operator is based on a location of the vehicle relative to a plurality of predefined areas, wherein the plurality of predefined areas are associated with one or more operators of the plurality of available operators.

In various embodiments, the selectively assigning the operator to the task is based on an evaluation of the economic element.

In various embodiments, the selectively assigning the operator to the task is further based on an evaluation of a task type of the skill level.

In various embodiments, the selectively assigning the operator to the task is further based on an evaluation of a vehicle type of the skill level.

In various embodiments, the selectively assigning the operator to the task is further based on an evaluation of the workload.

In various embodiments, the selectively assigning the operator to the task is further based on an evaluation of a capacity of the selected operator.

In various embodiments, the method includes selecting a new operator from the plurality of available operators based on the evaluation of the economic element.

In various embodiments, the economic element includes an operator or customer transport cost.

In various embodiments, the economic element includes an impact on service quality and cost if prioritization not selected.

In another embodiment, a system includes: a communication module configured to receive, from the autonomous vehicle, request data requesting intervention of control of the autonomous vehicle; an operator assignment module configured to, by a processor select an operator from a plurality of available operators, selectively assign the selected operator to a task associated with the intervention based on at least one of a skill level of the selected operator, a workload of the selected operator, and an economic element of the ride associated with the selected operator; and a control module configured to, by a processor, coordinate control of the autonomous vehicle based on the assigned operator.

In various embodiments, the operator assignment module is configured to select the operator from the plurality of operators based on a location of the vehicle relative to a plurality of predefined areas, wherein the plurality of predefined areas are associated with one or more operators of the plurality of available operators.

In various embodiments, the operator assignment module is configured to selectively assign the operator to the task based on an evaluation of the economic element.

In various embodiments, the operator assignment module is configured to selectively assign the operator to the task further based on an evaluation of a task type of the skill level.

In various embodiments, the operator assignment module is configured to selectively assign the operator to the task further based on an evaluation of a vehicle type of the skill level.

In various embodiments, the operator assignment module is configured to selectively assign the operator to the task further based on an evaluation of the workload.

In various embodiments, the operator assignment module is configured to selectively assign the operator to the task further based on an evaluation of a capacity of the selected operator.

In various embodiments, the operator assignment module is configured to select a new operator from the plurality of available operators based on the evaluation of the economic element.

In various embodiments, the system includes an analysis module configured to determine route based on the operator assignment.

In various embodiments, the system includes an analysis module configured to determine whether to add or remove operators from the plurality of available operators based on the assigned operator.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a fleet management system, in accordance with various embodiments;

FIG. 2 is a functional block diagram illustrating a transportation system having one or more vehicles as shown in FIG. 1 and a fleet management system, in accordance with various embodiments;

FIG. 3 is a functional block diagram illustrating the fleet management system of the vehicle, in accordance with various embodiments; and

FIG. 4 is a flowchart for a control process of the fleet management system of a vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

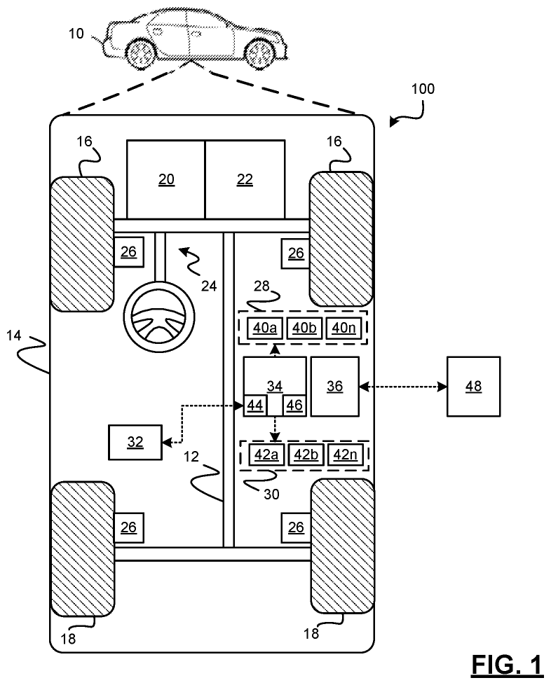

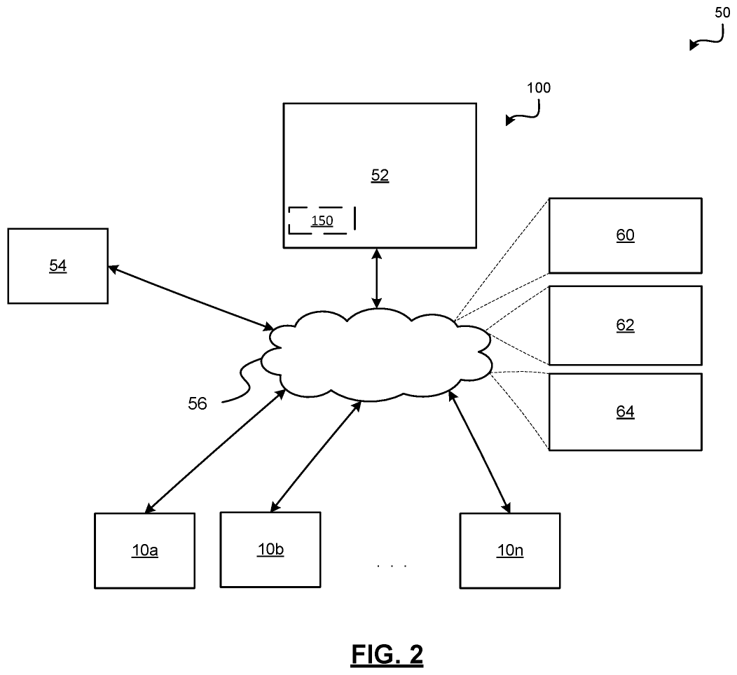

With reference to FIGS. 1 and 2, a fleet management system shown generally as 100 is associated with a vehicle 10 (FIG. 1) and a remote transportation system 52 (FIG. 2) in accordance with various embodiments. In general, the fleet management system (or simply “system”) 100 of the vehicle 10 interacts with the fleet management system 100 of the remote transportation system 52 to request operator assistance from, for example, an operator remote from the vehicle 10 and to accept instructions to assist autonomous operation of the vehicle 10 from the remote operator. In various embodiments, the fleet management system 100 of the remote transportation system 52 dynamically assigns the operator to the vehicle 10 based on determined criteria such as, but not limited to, operator workload, economic criteria, geospatial conditions, and operators' skill level.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the sensor alignment adjustment system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes requires operator assistance.

As shown, the vehicle 10 generally includes a propulsion system 20, a transmission system 22, a steering system 24, a brake system 26, a suspension system 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

The suspension system 27 connects the vehicle 10 and the wheels 16, 18. In various embodiments, the suspension system 27 provides support for different qualities of operation of the vehicle 10 that include road holding (e.g., steering stability), road handling (e.g., cornering), and road isolation (e.g., ride comfort). Also in various embodiments, the suspension system 27 includes one or more shock absorbers 71, springs 72 (e.g., in one embodiment, one or more airbags serving as springs 72), one or more adjustment systems 73 (e.g., a hydraulic system, electromagnetic system, and/or electromechanical system), and/or one or more other components (e.g., linkages, tires associated with the wheels 16, 18, actuators, and the like, among other possible components) that affect relative motion between the vehicle 10 and the wheels 16, 18.

The sensor system 28 includes one or more sensors 40a-40n that sense observable conditions of the exterior environment and/or the interior environment of the vehicle 10. The sensors 40a-40n include, but are not limited to, radars, lidars, global positioning systems, optical cameras, thermal cameras, ultrasonic sensors, inertial measurement units, and/or other sensors. The actuator system 30 includes one or more actuators 42a-42n that control one or more vehicle features such as, but not limited to, the propulsion system 20, the transmission system 22, the steering system 24, the brake system 26, and the suspension system 27. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10. In various embodiments, the data storage device 32 stores defined maps of the navigable environment. In various embodiments, the defined maps may be predefined by and obtained from a remote system (e.g., the remote transportation system 52 of FIG. 2). For example, the defined maps may be assembled by the remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In certain embodiments, the communication system 36 is further configured for communication between the sensor system 28, the actuator system 30, one or more controllers (e.g., the controller 34). For example, the communication system 36 may include any combination of a controller area network (CAN) bus and/or direct wiring between the sensor system 28, the actuator system 30, and/or one or more controllers 34.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, as discussed in detail below, the controller 34 is configured for use in determining a request for remote assistance from the remote transportation system 52 and receiving and coordinating implementation of instructions that remotely assist operation of the autonomous vehicle 10.

With specific reference now to FIG. 2, in various embodiments, the vehicle 10 described with regard to FIG. 1 may be suitable for use in the context of fleet of vehicles such as a taxi or shuttle service in a certain geographical area (e.g., a city, a school or business campus, a shopping center, an amusement park, an event center, or the like) or may simply be managed by a remote system. For example, the vehicle 10 may be associated with an autonomous vehicle based remote transportation system. FIG. 2 illustrates an exemplary embodiment of an operating environment shown generally at 50 that includes the autonomous vehicle based remote transportation system (or simply “remote transportation system”) 52 that is associated with one or more vehicles 10a-10n as described with regard to FIG. 1. In various embodiments, the operating environment 50 (all or a part of which may correspond to entities 48 shown in FIG. 1) further includes one or more user devices 54 that communicate with the vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a plurality of live advisors, automated advisors, an artificial intelligence system, or a combination thereof. The remote transportation system 52 can communicate with the user devices 54 and the vehicles 10a-10n to schedule rides, dispatch vehicles 10a-10n, and the like.

In various embodiments, the remote transportation system 52 includes remote assistance system 150 that is a part of the fleet management system 100. The remote assistance system 150 communicates with the fleet management system 100 of the vehicle to provide remote assistance to a requesting vehicle 10a-10n. In various embodiments, the remote assistance system 150 dynamically assigns a remote operator to the vehicle 10a to provide the assistance based on the determined criteria such as, but not limited to, operator workload, economic criteria, geospatial conditions, and operators' skill level.

In accordance with a typical use case workflow, when a vehicle 10a of the vehicles 10a-10b determines that assistance may be needed, the vehicle 10a computes a risk value based on a determined need for assistance to successfully complete a mission. In various embodiments, the vehicle 10a can determine an intervention type needed to complete the mission. The vehicle 10a communicates a request for intervention to the remote transportation system 52. The remote transportation system 52 evaluates the risk and/or the intervention type and dynamically assigns an intervention task to an operator of a pool of operators of the remote transportation system 52 The assigned operator then provides remote instructions to the autonomous vehicle 10a and the autonomous vehicle receives and executes the instructions to remotely control the vehicle 10a.

As can be appreciated, the subject matter disclosed herein provides certain enhanced features and functionality to what may be considered as a standard or baseline vehicle 10 and/or a vehicle based remote transportation system 52. To this end, a vehicle and a vehicle based remote transportation system can be modified, enhanced, or otherwise supplemented to provide the additional features described in more detail below.

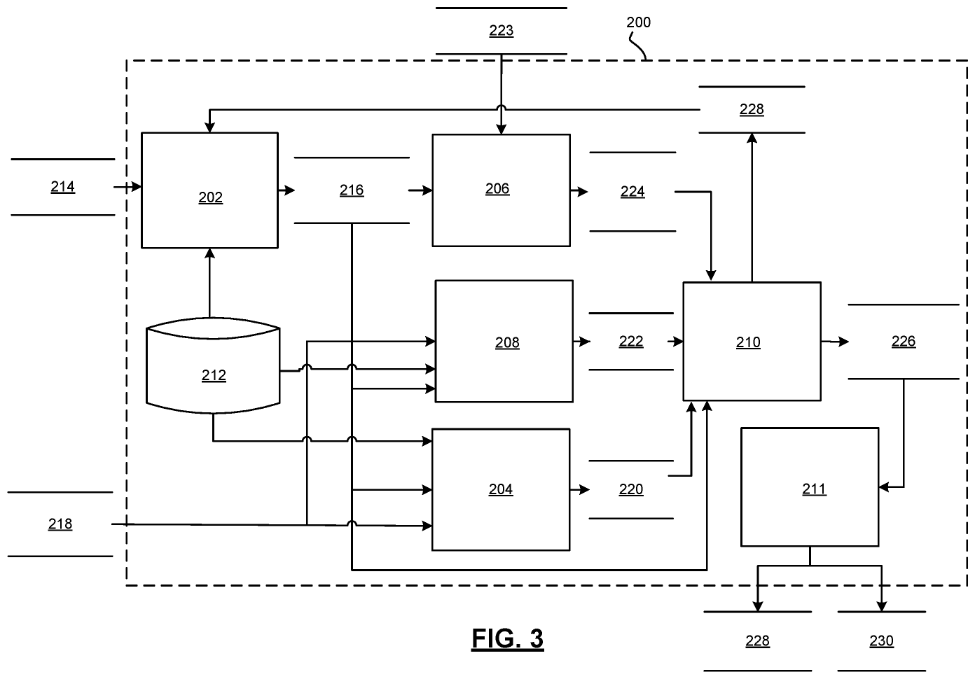

Referring to FIG. 3 and with continued reference to FIG. 1-2, a dataflow diagram illustrates the remote assistance system 150 of the system 100 in accordance with various embodiments. It will be understood that various embodiments of the remote assistance system 150 according to the present disclosure may include any number of sub-modules which may be combined and/or further partitioned to similarly implement systems and methods described herein. Furthermore, inputs to the remote assistance system 150 may be received from the vehicle 10a or other vehicles 10b-10n, other modules or systems (not shown) of the remote transportation system 52, and/or from other remote systems. Furthermore, the inputs may also be subjected to preprocessing, such as sub-sampling, noise-reduction, normalization, feature-extraction, missing data reduction, and the like.

In various embodiments, the remote assistance system 150 generally includes an operator selection module 202, a workload determination module 204, a skill level determination module 206, an economics elements determination module 208, an operator assignment module 210, a queueing analysis module 211, and an operator data datastore 212.

In various embodiments, the operator selection module 202 receives as input location data 214 of the vehicle 10 generating the request for intervention. The operator selection module 202 selects an operator based on the location of the vehicle 10 and generates operator selection data 216. For example, available operators may each be associated with one or more defined regions of a map (e.g., based on a familiarity with the area). A list of the available operators and their associations to the defined regions is stored in and retrieved from the operator data datastore 212. The operator selection module 202 selects an operator from the list based on the association with a region that includes or is nearest to the location of the vehicle 10. As can be appreciated, more than one operator may be associated with any one particular region, in various embodiments. In such case, the operator selection module 202 may select the operator based on a level of familiarity the operator has with the region.

In various embodiments, the workload determination module 204 receives as input task data 218 that indicates the intervention task to be performed by the operator, and the selected operator data 216. The workload determination module 204 determines the current workload of the selected operator, for example, based on a number of tasks currently assigned to the selected operator. The workload determination module 204 then determines whether the current workload permits assignment of the new task to the selected operator.

In various embodiments, the operator's capacity can be learned over time and stored in and retrieved from the operator data datastore 211. The current workload plus the new task can be compared to the capacity to determine whether it is appropriate to assign the task to the selected operator. For example, when the current workload plus the new task is greater than the capacity, then the workload determination module 204 determines that it is not appropriate to assign the task to the selected operator and workload data 220 is generated to indicate such. In another example, when the current workload plus the new task is less than or equal to the capacity, then the workload determination module 204 determines that it is appropriate to assign the task to the selected operator, and the workload data 220 is generated to indicate such.

In various embodiments, the skill level determination module 208 receives as input the operator selection data 216, and the intervention task data 218. The skill level determination module 208 determines the skill level for the selected operator. For example, skill sets may be defined for the available operators and stored in and retrieved from the operator data datastore 212. The skill sets include tasks and vehicle types that the operator has experience with.

In various embodiments, the skill level determination module 208 retrieves the skill set associated with the selected operator from the operator data datastore 212. The skill level determination module 208 then compares the task to the skill set data to determine whether the task for the vehicle type falls within the operator's skill set. For example, when the task for the vehicle type falls within the operator's skill set, the skill level determination module 208 determines that it is appropriate to assign the task to the selected operator, and the skill level data 222 is generated to indicate such. In another example, when the task for the vehicle type falls outside of the operator's kill set, the skill level determination module 208 determines that it is not appropriate to assign the task to the selected operator, and the skill level data 222 is generated to indicate such.

In various embodiments, the economics elements determination module 206 receives as input cost data 223. The economics elements determination module 206 determines an operator cost or a customer transport impact on the ride for the selected operator. In various embodiments, the economics elements determination module 206 determines an economic value of physical or human assets transported. In various embodiments, the economics elements determination module 206 determines service quality and economic impact if prioritization not selected.

In various embodiments, the operator assignment module 210 receives as input the selected operator data 216, the workload data 220, the skill level data 222, and the economics element data 224. The operator assignment module 210 evaluates the input data for the selected operator to determine if the task is appropriate for the selected operator. When it is determined that the operator is appropriate for the task, the operator selection module 210 generates operator assignment data 226 indicating the assignment of the task to the operator.

In various embodiments, the operator assignment module 210 determines the assignment is appropriate when the workload data 204 indicates the workload is appropriate and the economics data 224 indicates the economics are appropriate. In various embodiments, the operator assignment module 210 determines the assignment is appropriate when the skill level data 222 indicates the skill level is appropriate and the economics data 224 indicates the economics is appropriate. In various embodiments, the operator assignment module 210 determines the assignment is appropriate when the economics data 224 alone indicates the economics is appropriate. In various embodiments, the operator assignment module 210 determines the assignment is not appropriate when the economics data 224 indicates that the assignment is not appropriate.

In various embodiments, when the operator assignment module 210 determines it is not appropriate to assign the selected operator to the task, the operator selection module 210 generates request data 228 to the operator selection module 202 to select a new operator. In various embodiments, the operator assignment module 210 determines it is not appropriate when the workload data indicates the workload is not appropriate and the skill level data 222 indicates that the skill level is not appropriate. In various embodiments, the operator assignment module 210 determines it is not appropriate when the economics data 224 indicates that the assignment is not appropriate.

The queuing analysis module 211 receives as input the operator assignment data 226. The queuing analysis module 211 evaluates the current vehicle routes assigned to the operator and other operators and determines if an easier route can be suggested so as to lengthen the neglect time between needing an operator intervention or to ameliorate a heavy load of an operator and generates route data 230 based thereon.

In various embodiments, the queueing analysis module 211 further determines whether additional optimizing is needed by adding operators to the list of operators or removing operators from the list of available operators and generating operator data 228 based thereon.

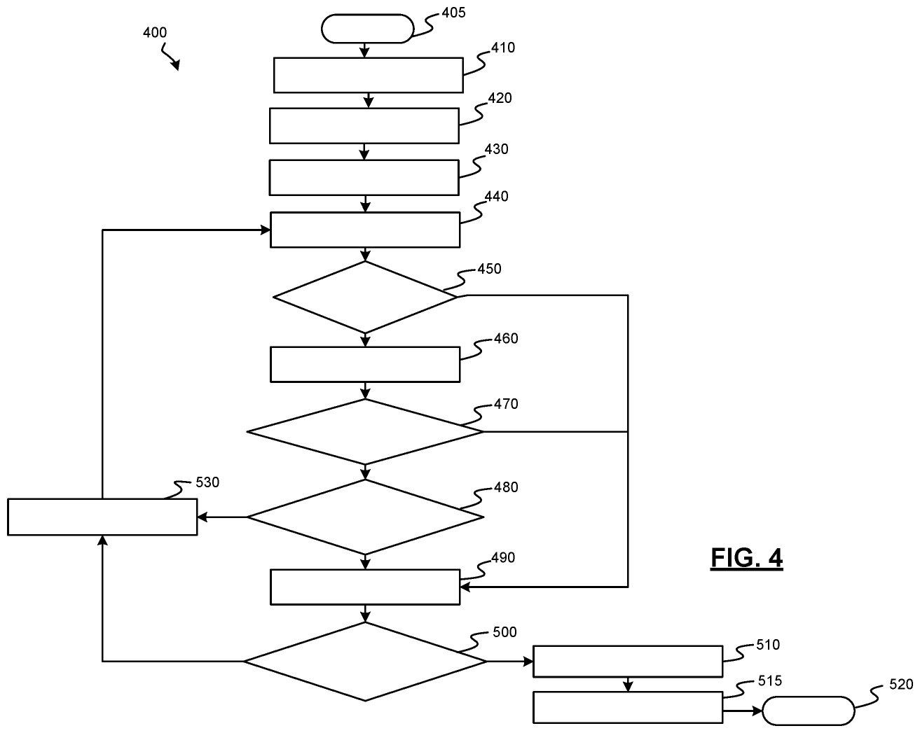

With reference to FIG. 4, a flowchart is provided for a control process 400 for performing a remote assistance to the vehicle 10, in accordance with an exemplary embodiment. In accordance with various embodiments, the control process 400 can be implemented in connection with the system 100 and vehicle 10 of FIG. 1, the transportation system 52 of FIG. 2, and the remote assistance system 150 of FIG. 3, in accordance with various embodiments. As can be appreciated in light of the disclosure, the order of operation within the control process 400 is not limited to the sequential execution as illustrated in FIG. 4 but may be performed in one or more varying orders as applicable and in accordance with the present disclosure. In various embodiments, the control process 400 can be scheduled to run based on one or more predetermined events, and/or can run continuously during operation of the remote transportation system 52.

In one example, the method may begin at 405. A request for operator assistance is received at 410. The geospatial conditions are determined at 420. An operator is selected from a pool of operators based on the geospatial conditions at 430. The selected operator's workload is determined at 440 and evaluated at 450. When the operator's workload is not appropriate for the intervention task indicated by the request, the operator skill level is determined at 460 and evaluated at 470 and 480. When the operator's workload is appropriate at 450, the economics elements are determined at 490 and evaluated at 500.

When the operator's skill level is not appropriate for the vehicle type associated with the request at 470, and when the operator's skill level is not appropriate for the task type at 480, a new operator is selected at 520. When the operator's skill level is appropriate for the vehicle type at 470 or the operator's skill level is appropriate for the task type at 480, the economics elements are determined at 490 and evaluated at 500.

When the operator is appropriate for the economic elements at 500, the operator is assigned to the task at 510. The queueing analysis is performed to determine route data and/or operator data at 515. Thereafter, the method may end at 520.

However, when the operator is not appropriate for the economic elements at 500, a new operator is selected at 530 and the method continues with determining the newly selected operator's workload at 440. The method continues until an operator is assigned to the task at 510 and the queueing analysis is performed at 515. Thereafter, the method may end at 520.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for coordinating remote control of an autonomous vehicle by a remote transportation system, comprising:
receiving, by a processor of the remote transportation system, request data requesting intervention of control of the autonomous vehicle;
selecting, by the processor, an operator from a plurality of available operators;
selectively assigning, by the processor, the selected operator to a task associated with the intervention based on at least one of a skill level of the selected operator, a workload of the selected operator, and an economic element of the ride associated with the selected operator; and
coordinating, by the processor, control of the autonomous vehicle based on the assigned operator.

2. The method of claim 1, wherein the selecting the operator from the plurality of operator is based on a location of the vehicle relative to a plurality of predefined areas, wherein the plurality of predefined areas are associated with one or more operators of the plurality of available operators.

3. The method of claim 1, wherein the selectively assigning the operator to the task is based on an evaluation of the economic element.

4. The method of claim 3, wherein the selectively assigning the operator to the task is further based on an evaluation of a task type of the skill level.

5. The method of claim 3, wherein the selectively assigning the operator to the task is further based on an evaluation of a vehicle type of the skill level.

6. The method of claim 3, wherein the selectively assigning the operator to the task is further based on an evaluation of the workload.

7. The method of claim 6, wherein the selectively assigning the operator to the task is further based on an evaluation of a capacity of the selected operator.

8. The method of claim 3, further comprising selecting a new operator from the plurality of available operators based on the evaluation of the economic element.

9. The method of claim 3, wherein the economic element includes an operator or customer transport cost.

10. The method of claim 3, wherein the economic element includes an impact on service quality and cost if prioritization not selected.

11. A system for coordinating remote control of an autonomous vehicle, comprising:
a communication module configured to receive, from the autonomous vehicle, request data requesting intervention of control of the autonomous vehicle;
an operator assignment module configured to, by a processor select an operator from a plurality of available operators, selectively assign the selected operator to a task associated with the intervention based on at least one of a skill level of the selected operator, a workload of the selected operator, and an economic element of the ride associated with the selected operator; and
a control module configured to, by a processor, coordinate control of the autonomous vehicle based on the assigned operator.

12. The system of claim 11, wherein the operator assignment module is configured to select the operator from the plurality of operators based on a location of the vehicle relative to a plurality of predefined areas, wherein the plurality of predefined areas are associated with one or more operators of the plurality of available operators.

13. The system of claim 11, wherein the operator assignment module is configured to selectively assign the operator to the task based on an evaluation of the economic element.

14. The system of claim 13, wherein the operator assignment module is configured to selectively assign the operator to the task further based on an evaluation of a task type of the skill level.

15. The system of claim 13, wherein the operator assignment module is configured to selectively assign the operator to the task further based on an evaluation of a vehicle type of the skill level.

16. The system of claim 13, wherein the operator assignment module is configured to selectively assign the operator to the task further based on an evaluation of the workload.

17. The method of claim 16, wherein the operator assignment module is configured to selectively assign the operator to the task further based on an evaluation of a capacity of the selected operator.

18. The system of claim 13, wherein the operator assignment module is configured to select a new operator from the plurality of available operators based on the evaluation of the economic element.

19. The system of claim 11, further comprising an analysis module configured to determine route based on the operator assignment.

20. The system of claim 11, further comprising an analysis module configured to determine whether to add or remove operators from the plurality of available operators based on the assigned operator.
